(19) United States
(12) Patent Application Publication
(10) Pub. No.: US 2021/0012293 A1
(43) Pub. Date: Jan. 14, 2021

(54) EVENT MANAGEMENT

(71) Applicant: BACKGATE, LLC, Portola Valley, CA (US)

(72) Inventor: David Conlan, Portola Valley, CA (US)

(73) Assignee: BACKGATE, LLC, Portola Valley, CA (US)

(21) Appl. No.: 16/922,957

(22) Filed: Jul. 7, 2020

Related U.S. Application Data
(60) Provisional application No. 62/873,188, filed on Jul. 11, 2019.
(60) Provisional application No. 63/013,394, filed on Apr. 21, 2020.

(51) Int. Cl. G06Q 10/10; G06Q 50/14; G06Q 50/28; G06Q 10/02; G06Q 20/04; G06F 16/29; G06K 19/07; G06K 7/10; G01C 21/34

(52) U.S. Cl. CPC G06Q 10/1093; G06Q 50/14; G06Q 50/28; G06Q 10/025; G06Q 20/127; G06F 16/29; G06K 19/0723; G06K 7/10366; G01C 21/3438; G06Q 20/045

(57) ABSTRACT

Obtain rider locations for horse riders of a horse show event, the rider locations including at least a first location associated with a first horse rider, the horse show event including a plurality of venues, each of the plurality of venues being associated with at least a different first venue location. Obtain horse locations for horses associated with the horse riders, the horse locations including at least a second location associated with a first horse associated with the first horse rider. Determine a first route for the first horse rider from the first location of the first horse rider to a first venue location. Determine a second route for the first horse from the second location of the first horse to the first venue location. Provide an interface through which the first route and the second route are accessible.

### CROSS-REFERENCE TO RELATED APPLICATIONS

The present application claims priority to U.S. Provisional Patent Application Ser. No. 62/873,188 filed Jul. 11, 2019 and entitled “Back-Gate Pitch Deck,” and U.S. Provisional Patent Application Ser. No. 63/013,394 filed Apr. 21, 2020 and entitled “Event Management,” the contents of each of which are hereby incorporated by reference herein.

### BRIEF DESCRIPTION OF THE DRAWINGS

FIG. 1 is a diagram of an example of a system for event management.

FIG. 2 is a diagram of an example of a venue navigation system.

FIG. 3 is an image of a screenshot on a smartphone that illustrates a minimalist dynamic location overlay for a portion of a venue.

FIG. 4 is an image of a screenshot on a smartphone that illustrates delivered amenities at a venue.

FIG. 5 is a screenshot of an example of an event participant status listing and management interface.

FIG. 6 is an image of a screenshot on a smartphone that illustrates a lineup view a competitor at an event might see.

FIG. 7 is an image of a screenshot on a smartphone that displays registrations.

FIG. 8 is an image of a screenshot on a smartphone that displays horse information.

FIG. 9 is an image of a screenshot on a smartphone that displays an interface for adding and scratching classes.

FIG. 10 is an image of a screenshot on a smartphone that displays an interface for checking horse attributes of competitors.

FIG. 11 is an image of a screenshot on a smartphone that displays an interface a trainer can use at a horse show.

FIG. 12 is a diagram of an example of a system for show office management.

FIG. 13 is a screenshot of an example of an event list interface.

FIG. 14 is a screenshot of an example of a horse list interface.

FIG. 15 is a diagram of an example of a score card to be completed.

FIG. 16 depicts a flowchart of an example method of horse event management.

FIG. 17 depicts a flowchart of an example method of near-real-time scoring.

### DETAILED DESCRIPTION

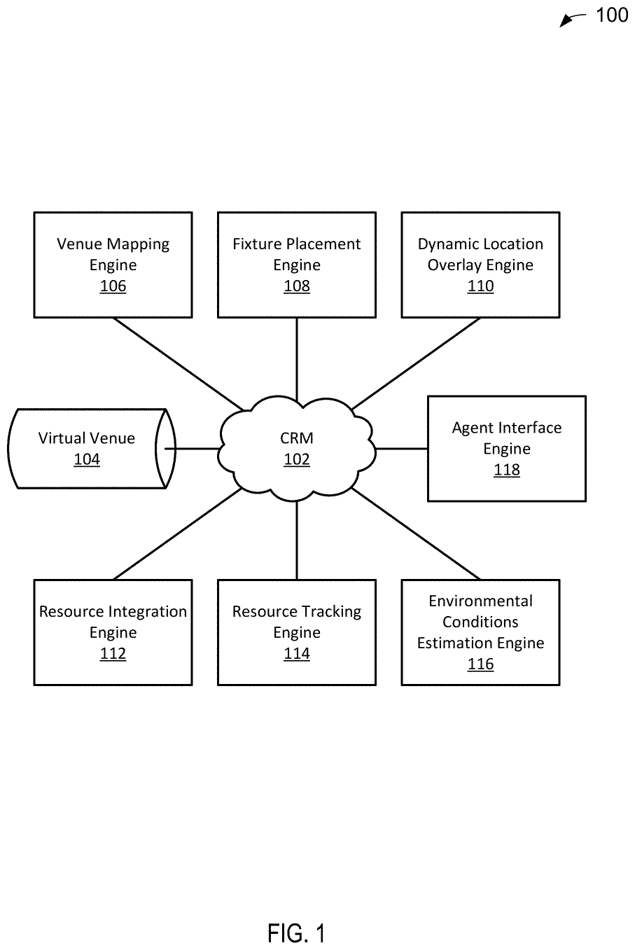

FIG. 1 is a diagram 100 of an example of a system for event management. The diagram 100 includes a computer-readable medium (CRM) 102, a virtual venue datastore 104 coupled to the CRM 102, a venue mapping engine 106 coupled to the CRM 102, a fixture placement engine 108 coupled to the CRM 102, a dynamic location overlay engine 110 coupled to the CRM 102, a resource integration engine 112 coupled to the CRM 102, a resource tracking engine 114 coupled to the CRM 102, an environmental conditions estimation engine 116 coupled to the CRM 102, and an agent interface engine 118 coupled to the CRM 102.

The CRM 102 in intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g. “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The virtual venue datastore 104 is intended to represent a datastore of static and dynamic objects within a venue, which can include places, people, animals, and things that can be tracked in some manner (e.g., via manual methods, such as checklists, or via sensors located around a venue, including cameras that can use facial recognition to determine a location of a person, or radios that can detect RFID or other electromagnetic signals of devices, such as RFID tags affixed to an object or a wireless signal from a smartphone) or for which a location and time are otherwise provided. Static objects can include buildings, ski resorts, outdoor arenas, bodies of water, competition rings, tracks (including waypoints along a track), show grounds, tables, booths, entrances, exits, and other places or fixtures. Static objects may or may not have a dynamic time component. For example, a location may be scheduled for multiple different events such that the space-time parameter values of an associated static location data structure in the virtual venue datastore 104 varies over time. In the context of a horse show, an arena can be scheduled for events every 30 minutes. In the context of a restaurant, a table can be reserved when the reservation is made, or a party is seated.

The virtual venue datastore 104 can include a historical virtual venue, which may be useful for revisiting a past event or “rewinding” for a moment. The virtual venue datastore 104 can include a current virtual venue, which is intended to represent, as accurately as possible, the venue in real time. The virtual venue datastore 104 can include a future virtual venue, which may be useful for scheduling and planning purposes. In at least some implementations, it is probably desirable for a human or artificial agent to be able to update the virtual venue datastore 104 quickly as data used to predict a future virtual venue change (e.g., if an arena needs to be shut down temporarily thereby delaying future events, if a party takes longer than expected at a table, if an event is canceled, or the like). Information about the venue (facility name, address, phone number, email address, maps/directions, etc.) can be considered part of the virtual venue datastore. In a horse show context, information about, for example, grooms, braiders, haulers; feed, hay, and bedding suppliers; tack suppliers; can also be considered part of the virtual venue datastore.

The venue mapping engine 106 is intended to represent an engine that creates, reads, updates, or deletes (CRUDs) the virtual venue datastore 104 to include data associated with a venue map. Such data can include building addresses, building blueprints, maps, paths (including, e.g., restricted areas, inaccessible areas, intended paths, difficult terrain (e.g., streams, ponds, mud, lakes, groves, bushes, or the like), and open areas that permit traversal but are not intended paths). Map locations do not vary over time but an event overlay can cause a map location to be treated differently (e.g., a stage could have an 8:00 show and a 10:00 show that would be distinct events in the same map location). As used in this paper, the events could be characterized as having identical locations and different times (or different space-times).

The fixture placement engine 108 is intended to represent an engine that CRUDs the virtual venue datastore 104 to include data associated with fences, tables, booths, and other things that are fixtures or are intended to act as fixtures for a span of time. (Note: Map locations could also be treated as static locations but are distinguished in this example of illustrative reasons.) An event administrator, or human or artificial agent thereof, can determine where to place fixtures and other objects intended to act as fixtures, which can include legacy objects, such as fences that are already in place. The degree to which a venue may need to be modified can have a bearing on how carefully real-world fixtures and objects intended to act as fixtures are tracked by the static location placement engine 108. For example, a semi-permanent fence could be assumed to remain in place for an event but protocol may require a temporary fence have its location verified with a snapshot after it is put in place.

The dynamic location overlay engine 110 is intended to represent an engine that CRUDs the virtual venue datastore 104 to include data associated with events with an associated timespan. For example, an arena can be used for different shows at different times during the day and a table can be used for different parties of diners throughout the day. In some instances, fixtures or objects intended to be treated as fixtures can be treated like dynamic locations to the extent they are monitored to ensure they remain in place. For example, a table may be affixed with a wireless device to make it part of the IoT (the table and the wireless device can collectively be considered a “thing” in the IoT), its location being monitored to ensure it is in place at a start time and remains in place until an end time. However, for illustrative purposes, it is assumed objects intended to act as fixtures are treated as static during a relevant timespan even if their location is tracked. More generally, the time component of an area is what defines the area as an event (dynamic location).

The resource integration engine 112 is intended to represent an engine that enters a resource into a venue. From the context of participants (e.g., horse riders), the resource could be the participants themselves and, potentially, assistants, guests, animals, equipment, and the like. In a specific implementation, the smartphone of a participant (human resource) acts as a location device and portal into the virtual venue datastore 104. Instead or in addition, a participant can be provided a physical device, such as a badge or placard, that is detectable by the resource tracking engine 114.

Once integrated into the virtual venue, participants can see (e.g., on their smartphones) time and distance from events, making it unnecessary to crowd a competition ring to determine when it is their turn to go. Advantageously, participants can reduce wasted time while enabling social distancing. For example, participants can be alerted that it is their turn to compete, so they know when to go to the ring. In a horse show context, competitors usually need to congregate around the competition ring or start gate because no one really knows what is going on, in addition to standing in line to sign up for a show, standing in line to make changes to their show schedules, and standing in line to sign out at the end of a show. Indeed, in the context of horse shows, riders can stay in the barn with their horses in lieu of having to wait, often 30-45 minutes, for a turn at the competition ring under the hot sun, sweating through their jackets, trying to remember the course while working to keep a 1200 pound animal to stand still.

The resource tracking engine 114 is intended to represent an engine that tracks a current location of a resource and CRUDs the virtual venue datastore 104 with the data. In the context of this paper, an asset can include a person. In the context of a horse show, the resource can include a rider (competitor), trainer, judge, photographer, groundskeeper, horse, and/or pieces of equipment (such as a badge, piece of equestrian gear, or some other device configured for radio communication, such as RFID, tracked explicitly, such as via a checklist, or the like). What is considered a “resource” can depend upon the entity tracking the resource. For example, a competitor may not care about the location of a groundskeeper, so even for a venue that defines the groundskeeper as a human resource, competitors may not have access to the data.

In a specific implementation, the resource tracking engine 114 includes a device used to track the position of a resource. Examples of sensors include cameras, RFIDs, 802.11-compliant radios, GPS devices, or the like. An entity that uses a sensor under their own control to obtain location data may or may not choose to publish the location data to a centralized datastore. For example, a competitor may choose to track their own location so it can be compared to the start time and place for an event in which they will compete but not share their location with anyone else (or share with a limited number of parties). All such data can be considered part of a comprehensive virtual venue datastore. In the context of this paper, however, unpublished location data (or data otherwise unavailable to an event administration application) is not considered part of the virtual venue datastore 104 unless explicitly stated or context dictates. It may be noted, however, that a competitor that chooses not to share location information can still be detected through other channels, if applicable, and the virtual venue datastore 104 will include such data; data can also be anonymized. For example, a competitor may have a short-range RFID tag that enables location detection at or near the entrance of an arena.

The granularity of a location update is configuration-, implementation-, or preference-specific. For example, a competitor may want to know an estimated time of arrival (ETA) at an event from a current location at any time, making it desirable to update competitor location frequently. In this example, the competitor could rely upon available location and time parameters for an event in which the competitor will compete and apply unshared location data and current time to the known location and time of the event. In a specific implementation, the unshared location data is compared with the known location and time data to provide an estimated ETA. The estimate can be improved with knowledge of competitor speed (e.g., walking, riding, driving, etc.) and the venue itself (e.g., crowds, need for assisted transit, paths, routes, etc.).

The environmental conditions estimation engine 116 is intended to represent an engine that tracks conditions, such as weather, crowds, accidents, or the like, and CRUDs the virtual venue datastore 104 to more accurately virtually represent real-time (or predicted) conditions at a venue. In some instances, it may be desirable to gain access to a third party datastore, such as a weather prediction service, to improve prediction accuracy of parameters of a future virtual venue.

The agent interface engine 118 is intended to represent an engine that enables a human or artificial agent to access the virtual venue datastore 104. What data is accessed will depend upon the type of agent. For example, a competitor may use an application on a smartphone to find, join, determine location of, and take other actions with respect to events. The application can include a billing component, a feedback component, and a local datastore integration component (e.g., to compare a current location and time to that of an event and provide an ETA). Marketers, teachers, purchases (e.g., horse buyers), event coordinators, restauranteurs, hospital administrators, guests, and other individuals will have other interests and can be provided data accordingly. Some examples are described below.

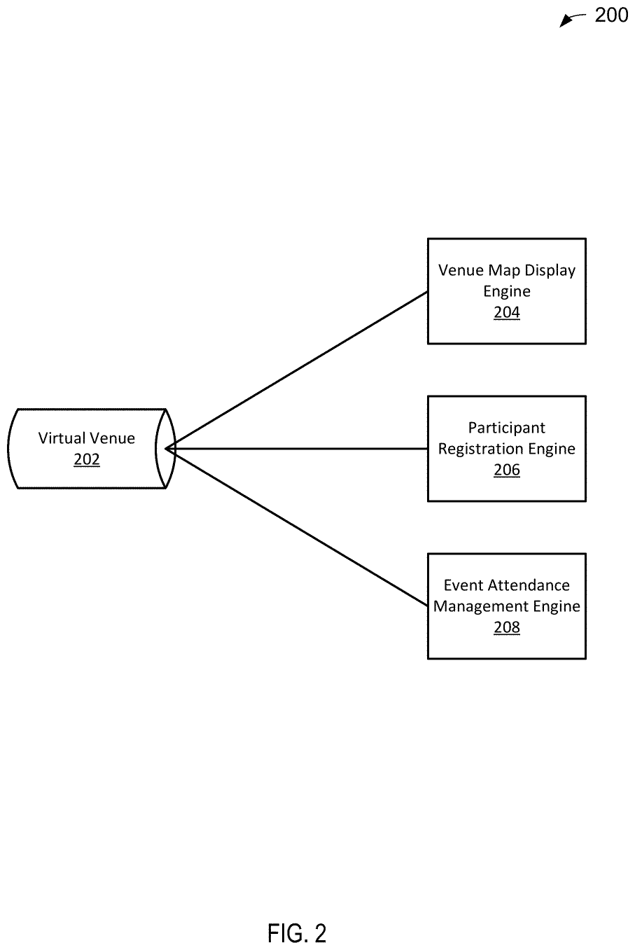

FIG. 2 is a diagram 200 of an example of a venue navigation system. The diagram 200 includes a virtual venue datastore 202, venue map display engine 204, a participant registration engine 206, and an event attendance management engine 208.

The virtual venue datastore 202 includes maps, locations, and events to which a human can navigate. In a specific implementation, a venue participant can also sign up, sign in, buy tickets, and take other actions that facilitate getting to and/or participating in an event.

The venue map display engine 204 is intended to represent an engine that displays a venue map from the virtual venue datastore 202 with a dynamic location overlay. In a specific implementation, at least one map is static, with a dynamic overlay that is associated with multiple events at a single static location. For example, a morning event and an evening event may take place at a single location and both would be represented on the static map. One reason to include a static map is humans have been trained to view maps as static things. Instead or in addition, a venue participant can select between a static venue map, a dynamic venue map.

Depending upon implementation-, configuration-, or preference-specific factors, dynamic venue maps can include, historic venue maps, a current venue map, and future venue maps. If an event is ongoing, one of the dynamic venue maps will be a current venue map and the others can be historic venue maps (if an event is over) or future venue maps (if an event has not yet begun). The granularity of time-increments used to distinguish between multiple dynamic maps can vary depending upon how rapidly a dynamic overlay changes. For example, if there are only morning and evening shows at a venue (and ignoring a current venue map for the moment), there may only be two historic venue maps (if the events are over), two future venue maps (if the events have not started), or one of each (if one event is over and one has not yet started). For events that change in concert (e.g., all event times start on the hour), granularity can be set to that amount, though it may be desirable to include a “it has been delayed” flag if the granularity is course. For events that change independently of one another, the granularity may be further reduced. For example, a cinema may have multiple movies of different durations playing on multiple screens. In such a scenario, the dynamic overlay may vary every 5 minutes (or every 1 minute if the granularity is down to the minute). Also, increments need not necessarily be the same; for example, a dynamic event slider could span ‘x’ minutes for a first increment, from the start time of a first event to the start time of a second event (not necessarily at the same location), and then ‘y’ minutes for a second increment, from the start time of the second event to the start time of a third event, where x≠y.

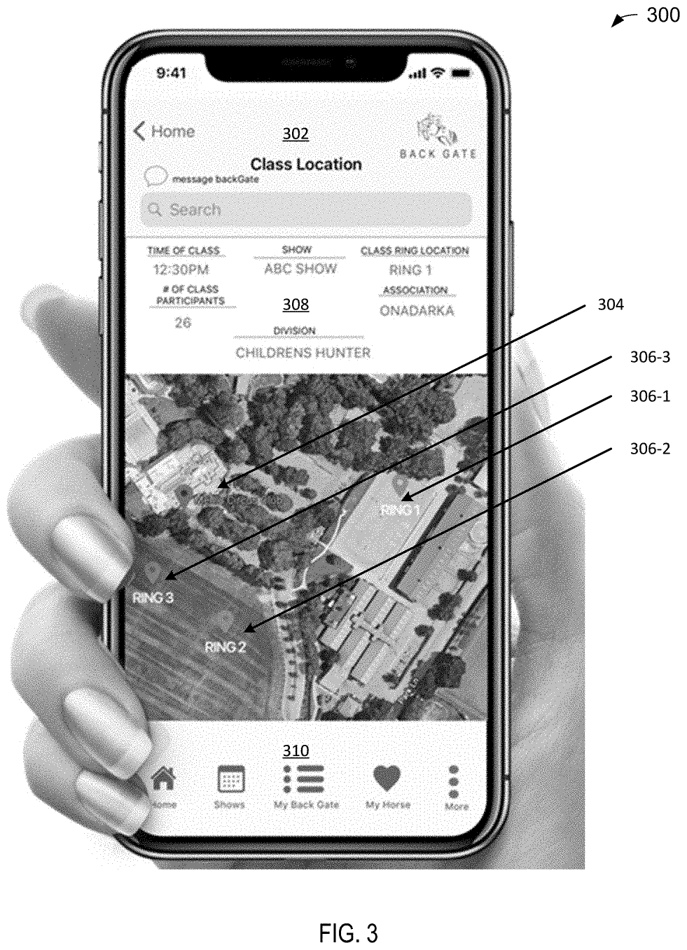

Some venues are huge, such as the Desert International Horse Park, which is 1.25 million square feet in area, and which is a popular venue for horse shows. For even moderately sized venues, a map with a dynamic location overlay can be exceptionally useful. FIG. 3 is an image 300 of a screenshot 302 on a smartphone that illustrates a minimalist dynamic location overlay for a portion of a venue. The example of FIG. 3 is in the context of a horse show. The venue location, as indicated by a red marker 304, is “Menlo Circus Club.” A dynamic overlay is partially represented by three blue markers 306-1, 306-2, and 306-3 (collectively, the dynamic overlay markers 306). The blue marker 306-1 marks “RING 1,” which, for illustrative purposes has been selected such that some details of an event at RING 1 are provided in an event panel 308. By way of example, the time of the event (class) is 12:30 PM, the name of the event is “ABC Show,” the class rink location (static location) is Ring 1, the number of participants is 26, the association is Onadarka, and the division is “Children's Hunter” division. In a specific implementation, each class is connected to an association, but the information displayed when an event is selected is implementation-, configuration-, and/or preference-specific. A menu bar 310 is also depicted.

It may be desirable to provide amenities at a relatively large venue. Such amenities can include restrooms, restaurants, gift shops, and other amenities, whether in static or mobile form. In the context of a venue navigation system, amenities are assumed to have a physical form such that navigation of the venue for delivery purposes is relevant. Advantageously, you can also have mobile or deliverable amenities come to you, which can improve your ability to remain in an environment you prefer, practice social distancing, or save time. To the extent it is desirable to distinguish between mobile amenities that can be summoned (e.g., a pizza delivery) and mobile amenities that cannot (e.g., an ice cream vendor), the former can be referred to as delivered amenities.

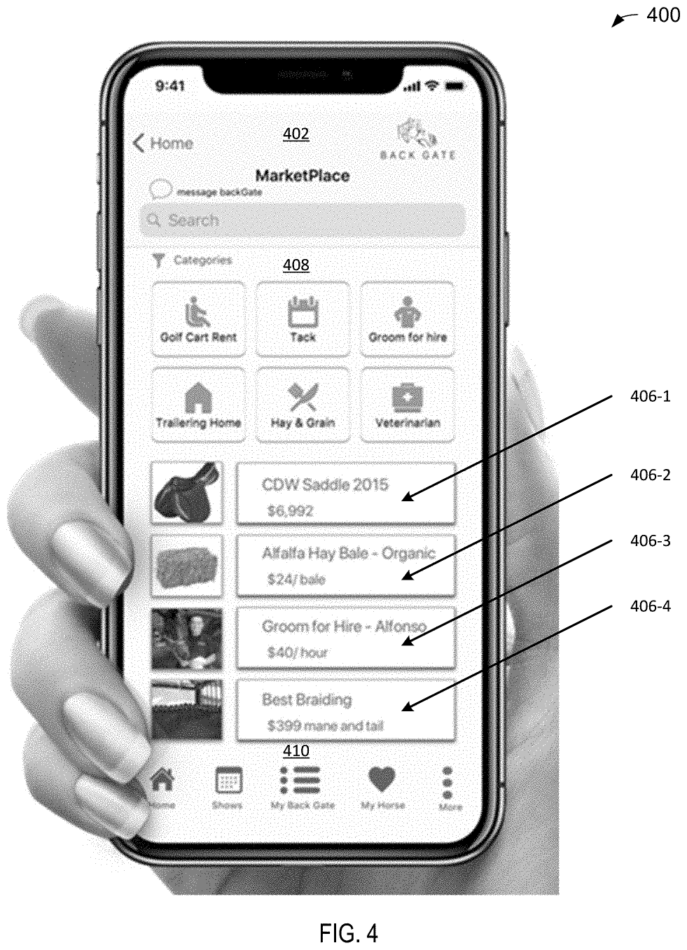

FIG. 4 is an image 400 of a screenshot 402 on a smartphone that illustrates delivered amenities at a venue. The example of FIG. 4 is in the context of a horse show. Amenities are represented by graphical objects 406-1, 406-2, 406-3, and 406-4 (collectively, the graphical objects 406). The graphical object 406-1 indicates “CDW Saddle 215” can be delivered for $6,992 (and an image of the saddle is also provided). The graphical object 406-2 indicates “Alfalfa Hay Bale—Organic” can be delivered for $40/bale (and an image of the bale is also provided). The graphical object 406-3 indicates “Groom for hire—Alfonso” is available for $40/hour (and an image of the groom is also provided). The graphical object 406-4 indicates “Best Braiding” can be provided for $399 for mane and tail (and an image of braiding is also provided). An amenities pane 408 can be used to sort amenities, but amenity categorization and sorting is implementation-, configuration-, and/or preference-specific. A menu bar 410 is also depicted.

Referring once again to the example of FIG. 2, the participant registration engine 206 is intended to represent an engine that gathers information about participants and associated animals or devices, if applicable. In a specific implementation, registration can include entering multiple events (e.g., classes at a horse show in which a rider will compete). Initial registration information can be shared with a venue, used to autofill future registrations, used to stop cross-entries, used to prevent registration for events for which a participant is ineligible, or the like, if applicable. In a horse show context, such information can include rider name (though a restriction on showing the last name of a minor may be enforced, assuming names are shared), rider association number(s), address, phone number, email, date of birth/age (note: show age changes December 1), and horse info (e.g., name, age, height, association number). Horse owner information may also be collected because owners can have multiple horses in a show and it may be useful to know name and/or corporate entity of owner, address, phone number (of trainer and/or owner), email (of trainer and/or owner), and pictures. Horse information can be useful for horse selling and is useful for other purposes, as well. Horse information can include name, gender (e.g., mare, stallion, gelding), height (normally measured in hands), breed (e.g., Dutch Warmblood, Belgian Warmblood, Holsteiner, Selle Français, Oldenburg, Hanoverian), lineage (e.g., horse's father, mother, grandfather, grandmother, etc.), color (e.g., bay, chestnut, gray, black, paint), show records (e.g., European show records, American show records from the United States Equestrian Federation, and others), pictures, association numbers, and price (plus an indication as to whether the horse is for sale, if applicable, which can be made visible to other participants or interested parties). It may be desirable to register (or acquire) trainer information, such as name, phone number, email, association number(s), riders they train, and horses they train because the system can rank trainers against one another (and give the trainers the ability to advertise services).

Breed, lineage, show records and the like can be obtained from HippoMundo and, in a specific implementation, HippoMundo integration is enabled. In a specific implementation, a driver's license number can be entered, which can be used to indicate whether a participant is a minor (triggering such actions as hiding last name from others, activating a last name entry field only after a driver's license has been entered, or the like). The system can use information to determine classes within a division a rider is signed up for, associate points with a rider for each event in which they participate (points are aggregated for each class and totaled by division), and provide the ability to add and scratch from an event. Associations (e.g., USEF, PCHA, NORCAL, OHJA) are tracked because they can sponsor multiple divisions and riders must be members of an association to capture points for sponsored division and class; association membership impacts eligibility to participate in classes, so riders are given a unique number from each association in which they have membership. In a specific implementation, individuals can readily see how many points are needed to qualify for medals through an API to a relevant association.

Point and award updates are later associated with registrants. Points and awards are associated with riders for each class for each association. Points are totaled by class for awards in a division. Associations have unique point value systems. Each rider is linked to multiple associations and each association has a member number.

An aspect of participant registration is integrating the participant as described above with reference to the resource integration engine 112 (FIG. 1). Upon registration, participants can be tracked like other resources, when the participant comes within range of a sensor or when the participant or an agent thereof otherwise provides location information.

The event attendance management engine 208 is intended to represent an engine that facilitates time management (and social distancing) for a venue participant. In a specific implementation, event participants are queued. An aspect of event attendance taking is integrating the participant as described above with reference to the resource integration engine 112 (FIG. 1). For example, the event attendance and queuing engine 208 can detect who enters a ring area, and then who enters a ring from the ring area. In a specific implementation, this is accomplished using a combination of GPS and RFID. The GPS is used for location within the show and the RFID is used for when the rider enters the ring. By using GPS, the competition ring managers can see where each of their competitors are, live, on their iPad. This allows the competition manager to see who is close to their competition ring, and who is so far away that they should be passed over in favor of a closer competitor. The RFID allows for greater accuracy of location. The RFID reader is located at the entrance of the competition ring so that as competitor pass by the RFID reader, they are recorded as entering the ring. Each competitor's card will have an RFID chip on the back of it. Therefore, if you are a competitor, and you have been given a competition number, you will have RFID tracking capability. These two functions also facilitate social distancing. Using GPS and RFID, competitors within 6 feet of each other can be alerted.

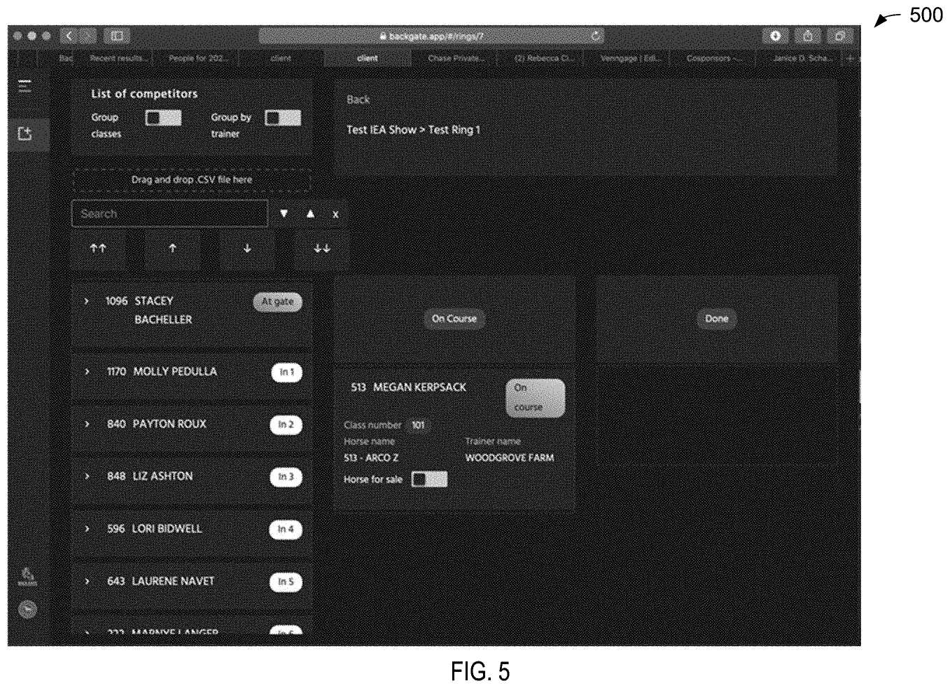

FIG. 5 provides an example of event attendance management for a horse show context. FIG. 5 is a screenshot 500 of an example of an event participant status listing and management interface. Riders (competitors) are listed “in line” waiting to compete with a next in line to compete is highlighted and ready to be dragged “on course.” After a competitor is done, the competitor can be dragged to “done.” In an alternative, an event coordinator could automate the status update using location tracking. For example, a competitor with an RFID tag that is detected at the entrance to a course could cause the system to update status to “on course” automatically, making it unnecessary to drag-and-drop or perform some other manual interaction to accomplish the status change.

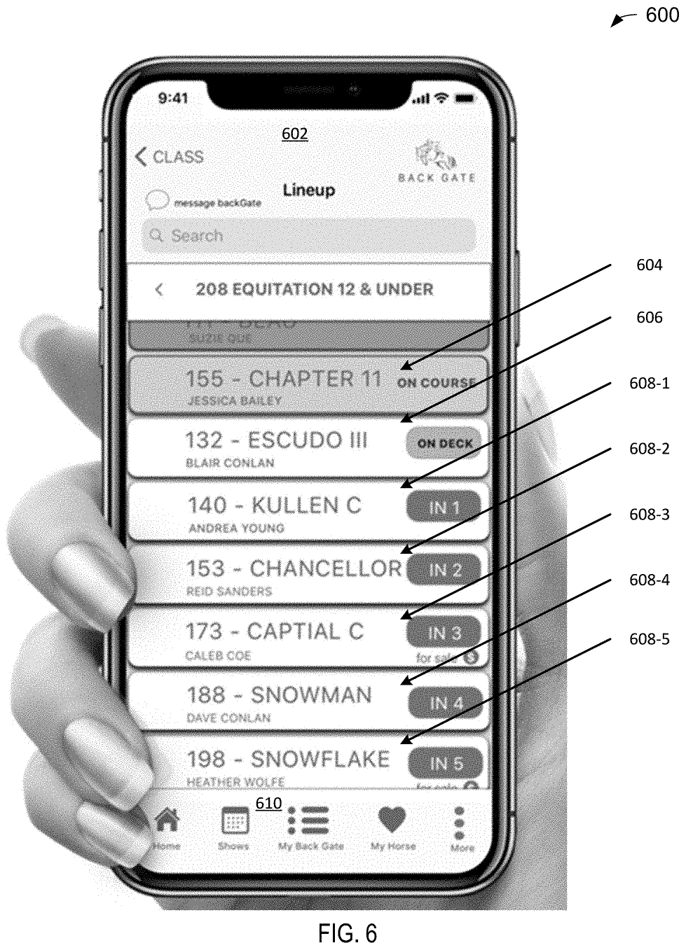

FIG. 6 is an image 600 of a screenshot 602 on a smartphone that illustrates a lineup view a competitor at an event might see. Individual competitors can decide when to move toward the event using the provided data and a venue navigation system, if applicable. Not illustrated in the lineup view is a social distancing alert that, in a specific implementation, generates a sound if a second competitor comes within 2 meters of a first competitor (from the first competitor's smartphone). Depending upon the technology, it may be necessary for both competitors to have an application installed to recognize one another and sound the alarm. Near field communications technology, such as Bluetooth, can be used for proximity detection.

The example of FIG. 6 is in the context of a horse show. A competitor graphical object 604 with an “on course” status is highlighted in green (in this example, the horse name and number and rider name are indicated). A competitor graphical object 606 is for a rider with an “on deck” status. Competitor graphical objects 608-1 to 608-5 (collectively, the competitor graphical objects 608) are for riders with a status indicating how far out they are from competing. A menu bar 610 is also depicted. In a specific implementation, clicking on a status provides an ETA from a current location to reach the relevant dynamic location.

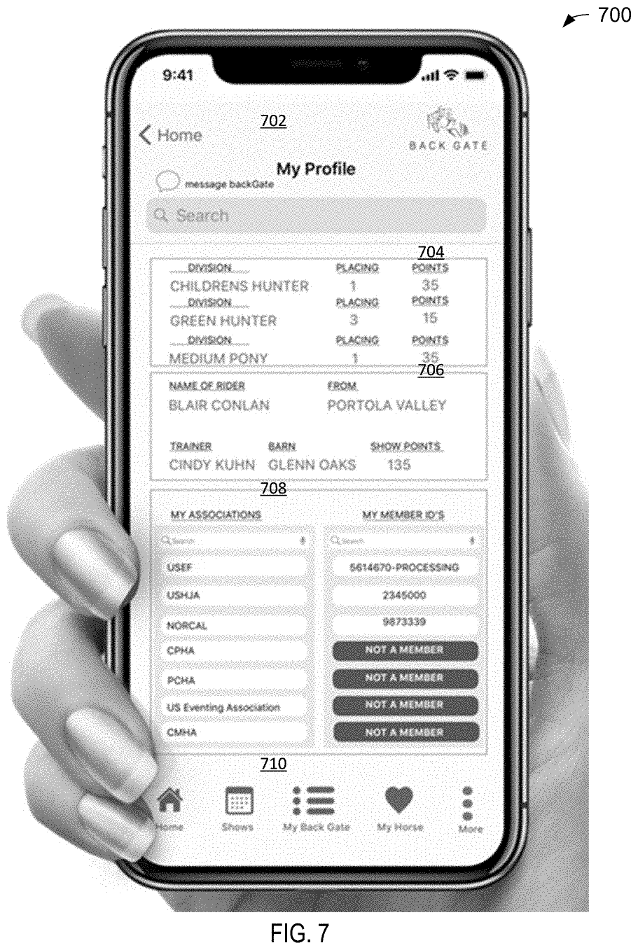

FIG. 7 is an image 700 of a screenshot 702 on a smartphone that displays registrations. The screenshot 702 includes a score panel 704, a rider information panel 706, an associations panel 708, and a menu bar 710. The score panel 704 shows placement and points per division. The rider information panel 706 displays rider name and where from, trainer name and barn, and show points for the trainer. The associations panel 708 lists associations and member IDs. Alternatives can include show age of rider, a picture, how many points are necessary to qualify for medals, or the like, which can be displayed in one of the panels, on a mouseover, on a click, or in some other applicable manner. Too often parents have no idea which associations they need to sign up for. This causes all kinds of problems after competitions because the associations almost always take the stand that “hey, if you aren't a member, your points don't count.” This and other functionality will provide both automated and visual (as a backup) ability to check membership and match events to membership before committing to the competition.

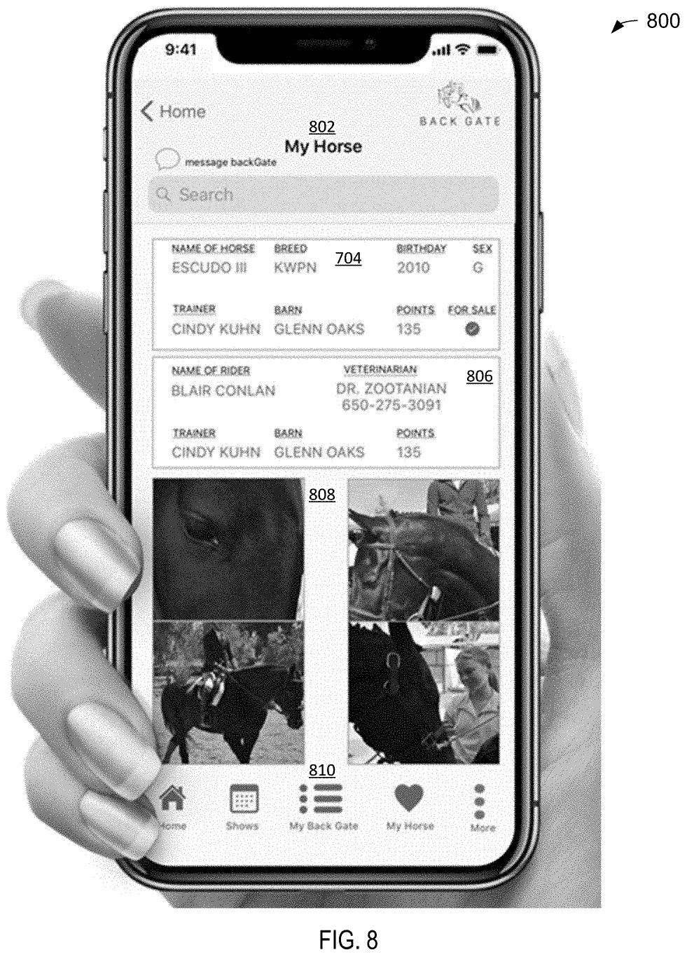

FIG. 8 is an image 800 of a screenshot 802 on a smartphone that displays horse information. The screenshot 802 includes a horse information panel 804, a people information panel 806, an pictures panel 808, and a menu bar 810. The horse information panel 804 displays information about the horse, including show name, breed, birthday, sex, trainer, barn, points (for the horse), and a for sale indicator. Other information could include height, association numbers, HippoMundo Integration options, competition results, vet records, ownership trace, or the like. The people information panel 806 displays information about people associated with the horse, including rider, veterinary, trainer, and points (for the trainer).

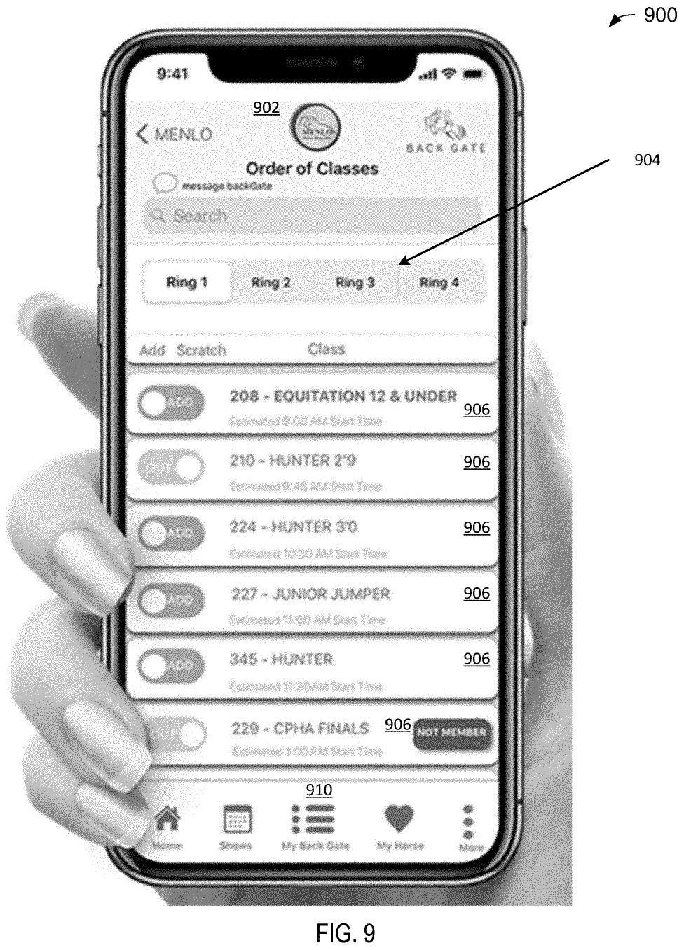

FIG. 9 is an image 900 of a screenshot 902 on a smartphone that displays an interface for adding and scratching classes. The screenshot 902 includes a ring selector graphical object 904, class graphical objects 906, and a menu bar 910. Advantageously, competitors and trainers can save a great deal of time using the illustrated interface and can maintain social distance. The ring selector graphical object 904 includes multiple areas (associated with real-world arenas) that can be selected to choose a ring of interest to the person interacting with the screenshot 902. The class graphical objects 906 are associated with classes provided in a selected ring, along with a start time of the classes and an add/scratch toggle. The add/scratch toggle prevents fraud at horse shows (e.g., a person adds a class, says they scratched it, and attempt to receive a refund for the supposedly scratched class).

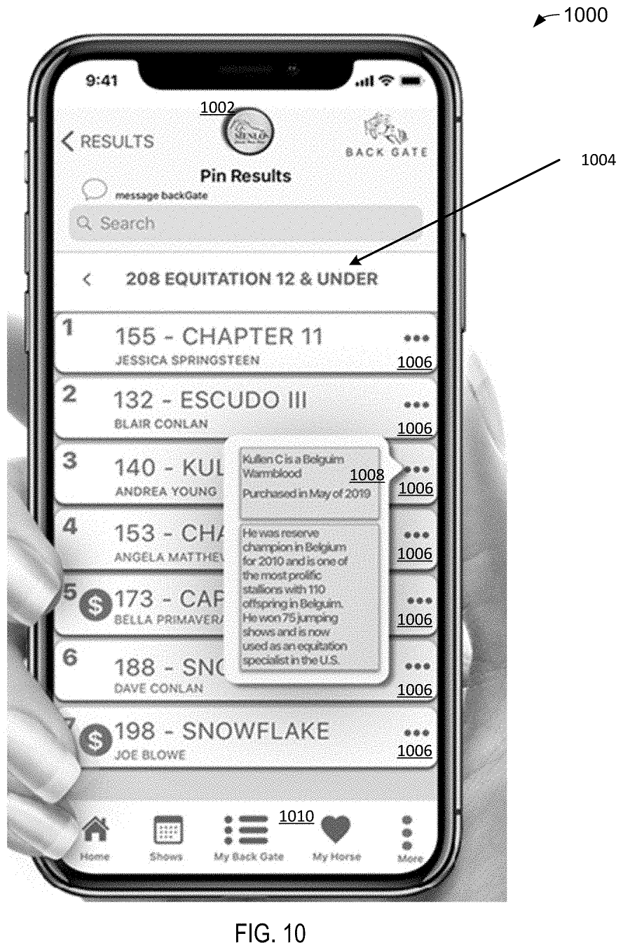

FIG. 10 is an image 1000 of a screenshot 1002 on a smartphone that displays an interface for checking horse attributes of competitors. The screenshot 1002 includes a class name text string 1004, horse selector graphical objects 1006, a horse attributes window 1008, and a menu bar 1010. The screenshot 1002 is intended to represent an example of how competitors within a class could be listed if selected from an interface such as is described by way of example with reference to FIG. 9. The class name text string 1004 indicates the class and the horse selector graphical objects 1006 represent competitors within the class.

For illustrative purposes, the horse attributes window 1008 displays attributes of a horse for a competitor that has been selected. Trainers are commonly looking for horses to buy for their clients and it is very difficult to find good horses because they are forced to approach other trainers to ask if they have “any horses for sale.” Advantageously, this innovation provides the ability to provide a list of horses that are for sale and removes difficulties associated with buying and selling horses at horse shows by providing data that would be relevant to a potential buyer at the relevant location (enabling trainers to see which horses are for sale, go see the horses compete, and have all relevant information), made readily accessible if the horse is for sale (potentially including less information if the horse is not for sale). This is important because it is very difficult for trainers to know which horses are for sale at horse shows.

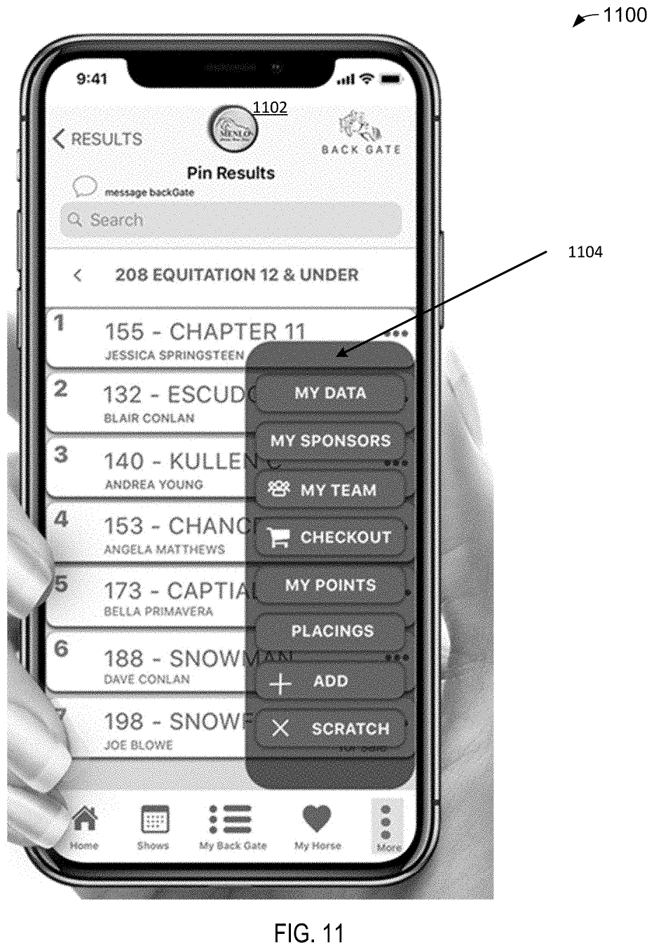

FIG. 11 is an image 1100 of a screenshot 1102 on a smartphone that displays an interface a trainer can use at a horse show. The image 1100 is similar to the image 1000 but illustrates options, illustrated by way of example with options window 1104, available to a person using an interface like that illustrated in the screenshot 1102. The options window 1104 includes, by way of example, “my data,” “my sponsors,” “my team,” checkout, “my points,” placings, add, and scratch options. The “my data” option of the options window 1104 is intended to represent an interface to data associated with a competitor, trainer, or other user. Data of others may be complete (if the person has full access, such as may be provided to a trainer or parent) or limited, and such data can be readily forwarded to people or uploaded to a social media platform. For example, automated messages can be sent to parents of a competitor (e.g., when a child places in a competition, gains a new sponsorship, or the like).

The “my sponsors” option of the options window 1104 is intended to represent an “opt in” to be a social influencer, tools for completing federal paperwork for tax and other purposes, data associated with sponsors. Advantageously, parties can be brought together in accordance with paleo-marketing principles (micro-sponsorship). For example, competitors can gain recognition through, e.g., winning and opt into micro-sponsorships so potential sponsors can bid on them. As social influencers, the competitors can opt into offering their services in saying good things about a sponsor on their social networks, which sponsors can monitor for messaging and activity effectiveness. In a specific implementation, potential sponsors bid for desired social influencers; competitors can place bids for those same influencers and the influencers can see the bidding for a micro-sponsorship contract (usually to say good things about a brand, stay out of trouble, etc.) and select one or more in accordance with their goals (e.g., most money, highest ethical rating, fewer restrictions, personal preference, or the like). Because the sponsorship is a micro-sponsorship, sponsors can generally lose relatively little money if a social influencer under-performs or can double down in the social influencer performs well; revenue can be in up-front payments, a commission, contingent on performance that is tracked through unique IDs to each sponsored influencer, or the like.

The “my team” option of the options window 1104 is intended to represent an interface to data associated with individuals on the competitor's team, which can include owners, trainers, parents, or the like. Such team members can gain access to a network associated with the competitor and have other advantages, as well (e.g., alerts if a trainer has been passed up by another trainer, updated points for students and horses for the year, judge biographies and the rings they judge, or the like). In some competitions, such as horse showing, judges have no set method for determining winners, so it may be desirable to track judges and compare to “people's choice” winners or using an objective metric; the importance of particular parameters for particular judges can then be made available.

The checkout option of the options window 1104 is intended to represent an interface to amenities as described previously in this paper (or options associated with the app).

Other possibilities include a “social” network for horses like LinkedIn or Facebook, a “people's choice” award for competitors, or the like. For example, competitors can be “upvoted” for things like good sportsmanship, friendliness, how cute a horse is, the attitude of the horse (e.g., nice, eager, willing), or the like. Positive social interaction increases serotonin, making all involved feel better (plus it is good for you), which can be encouraged with a system that rewards upvoting others. Also, judges are imperfect; it may be nice to have a “people's award” to override the judges and “keep them honest.” In a specific implementation, upvoting another provides a “people's choice” currency. In many contexts (e.g., restaurants), this can translate to coupons or discounts; in a competitive context, this can translate to an award or some form of recognition.

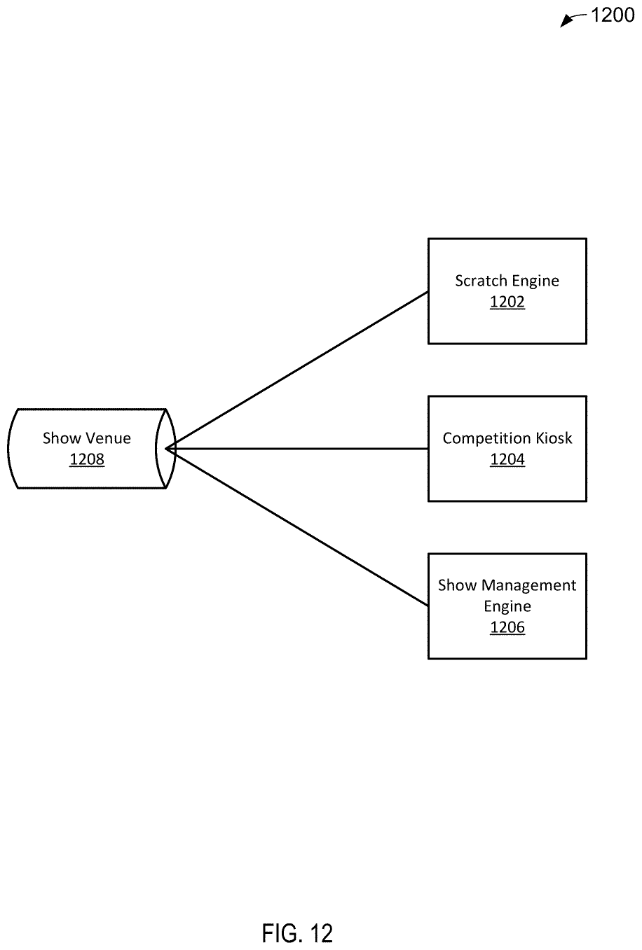

FIG. 12 is a diagram 1200 of an example of a system for show office management. The diagram 1200 includes a scratch engine 1202, a competition management kiosk 1204, a show management engine 1206, and a show venue datastore 1208. The scratch engine 1202 is intended to represent an engine that enables a show officer or agent thereof to cancel a competition class. In operation, a competitor pays for a competition class but may be unable to participate in the class, so they need to cancel (and therefore are not responsible for paying for the class). Historically, this has been accomplished using a paper scratch sheet filled out in triplicate (e.g., white copy is kept by the office, yellow goes to the back gate so they know you are not competing, and you keep the pink copy); there have been instances where trainers steal a pile of add/scratch slips and bring a pink copy to the office of scratched classes, where they are “refunded” for classes for which they never paid. Advantageously, the scratch engine 1202 creates a digital record of adds and scratches.

The competition kiosk 1204 is intended to represent engines and devices to be located within a competition office to assist with signup and other activities. In a specific implementation, the competition kiosk 1204 allows trainers to login using unique IDs, select a rider they want to scratch, confirm the rider is in the class to be scratched, confirm competition time has not passed (because you typically can't scratch a class that has already started), scratch the rider (triggering an engine of the competition kiosk 1204 to initiate a refund or credit), to name several activities. In a specific implementation, the competition kiosk 1204 includes a printer to enable the printing of paper receipts for office recordkeeping.

The show management engine 1206 is intended to represent engines for event management (see, e.g., FIG. 1), venue navigation (see, e.g., FIG. 2), or portions thereof. By communicating updates from the scratch engine 1202 and/or competition management kiosk 1204, the show management engine 1206 communicates relevant events to appropriate parties, such as updating a competitor that a class has been scratched. Advantageously, updates can prevent competition rings from staying open while waiting for riders who have scratched but the competition ring was not informed.

The show venue datastore 1208 is intended to represent data provided from the show management engine 1206 and other venue-related information.

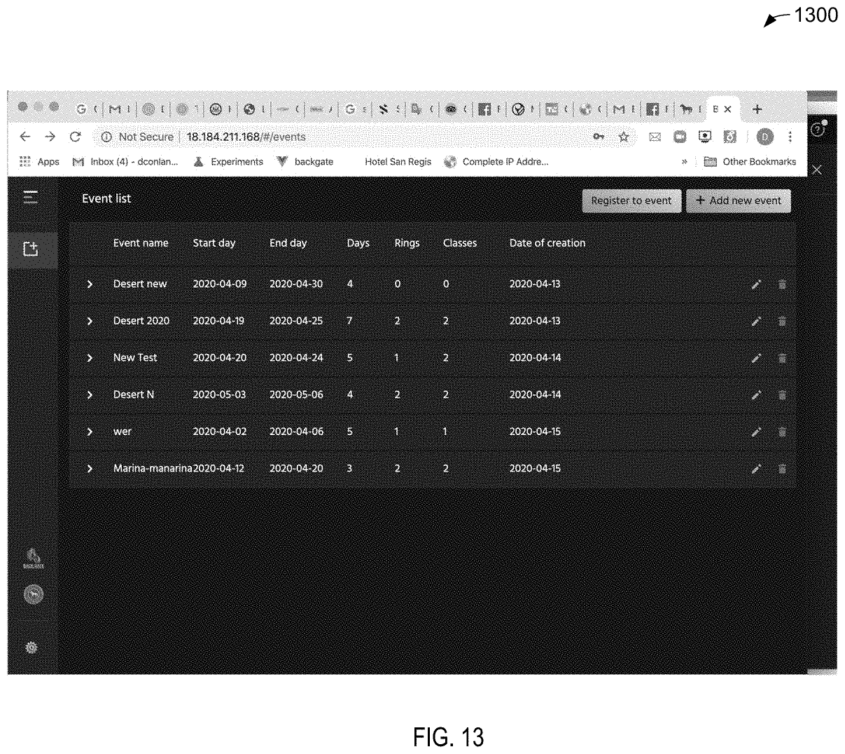

FIG. 13 is a screenshot 1300 of an example of an event list interface. As shown, the event list interface can display different events, and users can register to event(s), and/or add new event(s).

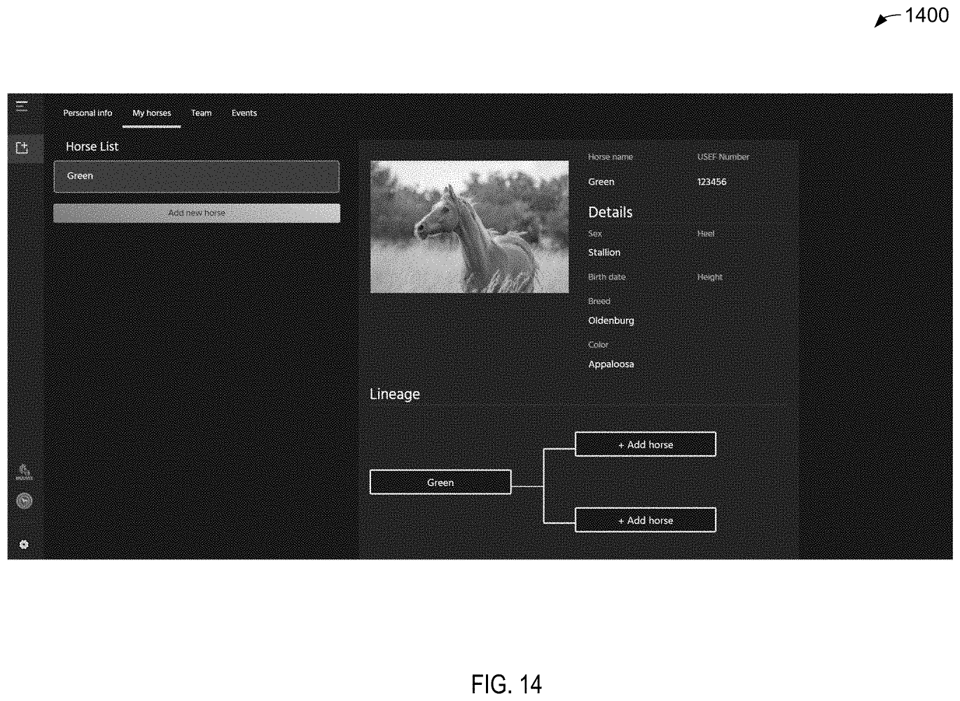

FIG. 14 is a screenshot 1400 of an example of a horse list interface. As shown, the horse list interface can display details and lineage for a particular horse, and users can add new horse(s).

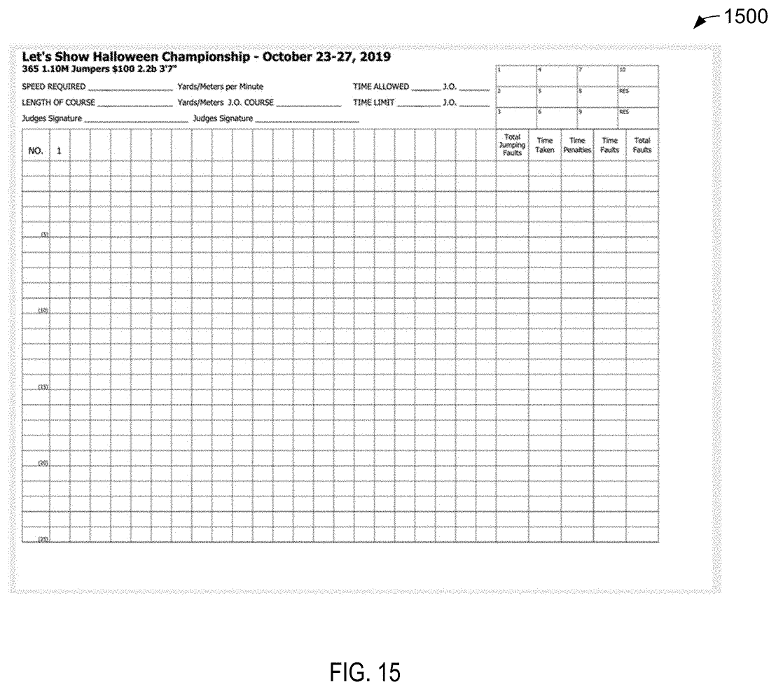

FIG. 15 is a diagram 1500 of an example of a score card to be completed. In some implementations, a process scan and/or upload a PDF (or other electronic format) of an existing score card (e.g., made of paper, card stock and/or other computer-scannable material) into a computer system to be delivered wirelessly to a plurality of mobile and stationary devices. Then users of the application may be able to provide user inputs (e.g., draw) on the PDF. The user inputs may include, for example, a variety of figures, type, or numbers. Once the user has finished drawing on top of the PDF picture, a button can allow the user to send their completed form to one or many other people through either email or through the system. In some implementations, the system has two columns integrated with the PDF whereby the numbers drawn on the PDF are converted into usable data for the system. This may allow, for example, the data to be processed by the system to provide near-real time rider scoring. The system can pull the data from the PDF to send real time updates of scores.

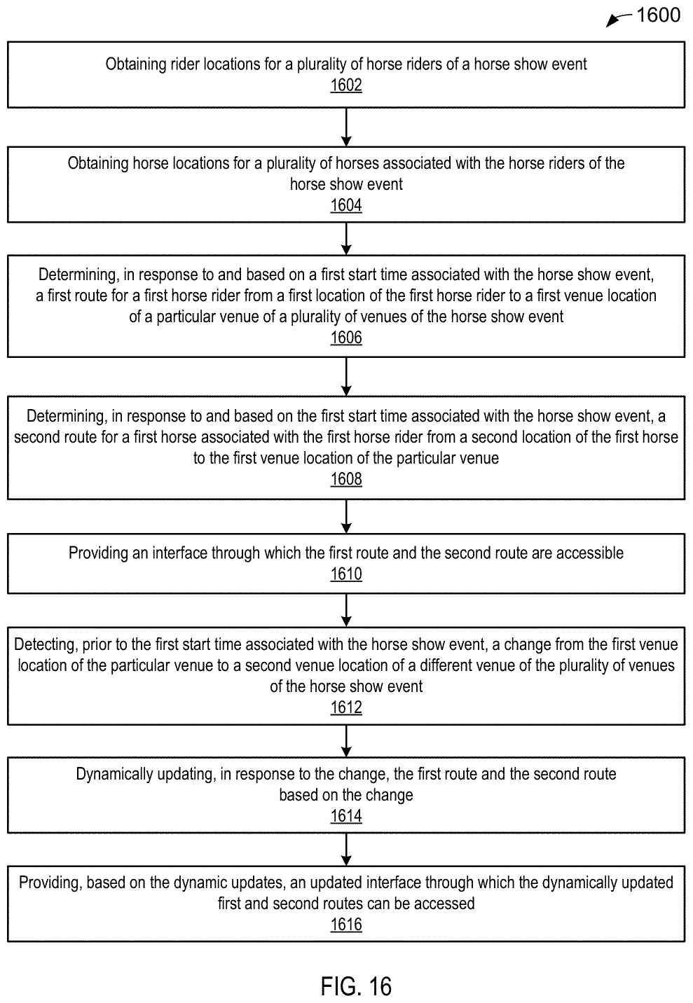

FIG. 16 depicts a flowchart 1600 of an example method of horse event management. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 1602, a system (e.g., the system for event management depicted in FIG. 1) obtains rider locations for a plurality of horse riders of a horse show event. The rider locations can include at least a first location associated with a first horse rider of the plurality of horse riders. For example, the first location can be a current location of the first horse rider. The current location can be an absolute location (e.g., a GPS location) and/or a relative location (e.g., relative to a position within the horse show event, venue, and/or the like). The horse show event can include a plurality of venues, and each of the plurality of venues can be associated with at least a different first venue location.

In step 1604, the system obtains horse locations for a plurality of horses associated with the horse riders of the horse show event. The horse locations can include at least a second location associated with a first horse of the plurality of horses associated with the first rider. For example, the second location can be a current location of the first horse, which may be different than the location of the associated horse rider. The current location can be an absolute location (e.g., a GPS location) and/or a relative location (e.g., relative to a position within the horse show event, venue, and/or the like.)

In some implementations, the first horse rider and the first horse are linked, and the first route and the second route can be determined based on the link. For example, the link can include a wireless network link (e.g., based on RFID, wireless LAN, and/or the like). Routes may be based on the link. Characteristics of the horse rider and/or horses and their relationship to each other may be used to determine routes. For example, if either a horse rider or a linked horse is instructed to go to a particular location, the other can be automatically instructed to go to the same location and/or different location(s) (e.g., a stable nearest to the destination of the horse rider). In another example, the routes may be based on how fast they can each travel, current information about how crowded areas may be, and/or the like.

In some implementations, the first route and the second are determined such that the first horse rider and the first horse are scheduled to arrive at the first venue location of the particular venue (and/or one or more other intermediate locations) at a same time. In some implementations, the first route and the second are determined such that the first horse rider and the first horse are scheduled to arrive at the first venue location of the particular venue (and/or one or more other intermediate locations) at different times.

In some implementations, horse riders and/or horses can be linked to judges (e.g., in the same manner as the linking of horses and horse riders). This may facilitate real-time scoring and allowing accurate tracking of which judge scored which horses and/or horse riders. This information may be collected and stored as historical information, which may be later audited (e.g., to determine if judges are scoring properly or improperly).

In step 1606, the system determines, in response to and based on a first start time associated with the horse show event, a first route (or, path) for a first horse rider of the plurality of horse riders from the first location of the first horse rider to the first venue location of a particular venue of the plurality of venues of the horse show event. For example, the start time (e.g., 10 AM) may be the start time of a particular event (e.g., race) for which the horse rider is registered.

In step 1608, the system determines, in response to and based on the first start time associated with the horse show event, a second route (or, path) for the first horse of the plurality horses associated with the first horse rider from the second location of the first horse to the first venue location of the particular venue of the plurality of venues of the horse show event.

In step 1610, the system provides an interface (e.g., graphical user interface) through which the first route and the second route are accessible (e.g., viewable, editable, and/or otherwise interactable). For example, the interface can include a first graphical layer overlaid over a second graphical layer. The first layer can be a dynamic layer and the second graphical layer can be a static map.

In step 1612, the system detects, prior to the first start time associated with the horse show event, a change from the first venue location of the particular venue to the a second venue location of a different venue of the plurality of venues of the horse show event. For example, the venue may have changed to another venue 0.25 miles away and/or to a different start time (e.g., 11 AM).

In step 1614, the system dynamically updates, in response to the change, the first route and the second routes based on the change. For example, the system can, in real-time, update the routes and/or create new routes to the new location. This can be performed any number of times to handle any number of venue changes, venue location changes, time changes, and/or the like.

In step 1616, the system provides, based on the dynamic updates, an updated interface through which the dynamically updated first and second routes can be accessed.

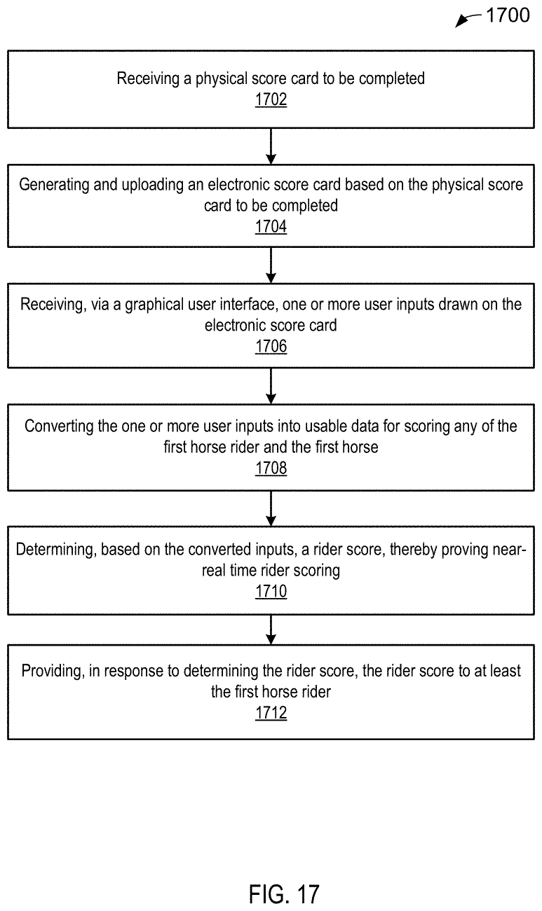

FIG. 17 depicts a flowchart 1600 of an example method of near-real-time scoring. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 1702, a system (e.g., the system for event management depicted in FIG. 1) receives a physical score card to be completed. In step 1704, the system generates and uploaded an electronic score card based on the physical score card to be completed. In step 1706, the system receives, via a graphical user interface, one or more user inputs drawn on the electronic score card. In step 1708, the system converts the one or more user inputs into usable data for scoring any of the first horse rider and the first horse. In step 1710, the system determines, based on the converted inputs, a rider score, thereby proving near-real time rider scoring. In step 1712, the system provides, in response to determining the rider score, the rider score to at least the first horse rider.

1. A system comprising:
one or more processors; and
memory storing instructions that, when executed by the one or more processors, cause the system to perform:
obtaining a first location associated with a participant at a venue;
registering the participant for a first event that is or will be scheduled to occur at a first venue location of a plurality of venue locations associated with the venue;
providing a scratch toggle that, when activated, indicates the participant is to be unregistered from the first event;
obtaining a second location, wherein the second location represents a location of a thing associated with the participant;
determining, in response to and based on a first start time associated with the first event, a first route for the participant from the first location to the first venue location;
disabling the scratch toggle when the second location matches the first venue location, wherein disabling the scratch toggle prevents the participant from being unregistered from the first event;
providing an interface through which the first route and the scratch toggle are accessible.

2. (canceled)

3. The system of claim 1, wherein the instructions further cause the system to perform:
detecting, prior to the first start time associated with the first event, a change from the first venue location to a second venue location of the plurality of venue locations; and
dynamically updating, in response to the change, the first route based on the change.

4. The system of claim 1, wherein the participant is a first horse rider of a plurality of horse riders in a horse show at the venue and the thing associated with the participant is a first horse.

5. The system of claim 4, wherein the memory stores instructions that, when executed by the one or more processors, causes the system to perform:
obtaining horse locations for a plurality of horses associated with the horse riders, the horse locations including at least the second location, wherein the second location is associated with a first horse of the first horse rider;
determining, in response to and based on the first start time, a second route for the first horse from the second location to the first venue location, wherein the first route and the second route are determined such that the first horse rider and the first horse are scheduled to arrive at the first venue location of the particular venue at a same time.

6. The system of claim 4, wherein the instructions cause the system to perform:
obtaining horse locations for a plurality of horses associated with the horse riders, the horse locations including at least the second location, wherein the second location is associated with a first horse of the first horse rider;
determining, in response to and based on the first start time, a second route for the first horse from the second location to the first venue location, wherein the first route and the second route are determined such that the first horse rider and the first horse are scheduled to arrive at the first venue location of the particular venue at different times.

7. The system of claim 1, wherein the first location represents a current location of the participant, and the second location represents a current location of the thing associated with the participant.

8. The system of claim 1, wherein the instructions cause the system to perform:
linking any of the participant and the thing associated with the participant to at least one judge responsible for scoring either or both the participant, and the thing associated with the participant.

9. The system of claim 8, wherein the instructions further cause the system to perform:
receiving a physical score card to be completed;
generating and uploading an electronic score card based on the physical score card to be completed;
receiving, via a graphical user interface, one or more user inputs drawn on the electronic score card;
converting the one or more user inputs into usable data for scoring either or both the participant and the thing associated with the participant;
determining, based on the converted inputs, a participant score, thereby proving near-real time participant scoring.

10. The system of claim 9, wherein the instructions further cause the system to perform:
providing the participant score to at least the participant via the interface.

11. A method implemented by a computing system including one or more processors and storage media storing machine-readable instructions, wherein the method is performed using the one or more processors, the method comprising:
obtaining a first location associated with a participant at a venue;
registering the participant for a first event that is or will be scheduled to occur at a first venue location of a plurality of venue locations associated with the venue;
providing a scratch toggle that, when activated, indicates the participant is to be unregistered from the first event;
obtaining a second location, wherein the second location represents a location of a thing associated with the participant;
determining, in response to and based on a first start time associated with the first event, a first route for the participant from the first location to the first venue location;
disabling the scratch toggle when the second location matches the first venue location, wherein disabling the scratch toggle prevents the participant from being unregistered from the first event;
providing an interface through which the first route and the scratch toggle are accessible.

12. (canceled)

13. The method of claim 11, further comprising:
detecting, prior to the first start time associated with the first event, a change from the first venue location to a second venue location of of the plurality of venue locations; and
dynamically updating, in response to the change, the first route based on the change.

14. The method of claim 11, wherein the participant is a first horse rider of a plurality of horse riders in a horse show at the venue and the thing associated with the participant is a first horse.

15. The method of claim 14, comprising:
obtaining horse locations for a plurality of horses associated with the horse riders, the horse locations including at least the second location, wherein the second location is associated with a first horse of the first horse rider;
determining, in response to and based on the first start time, a second route for the first horse from the second location to the first venue location, wherein the first route and the second route are determined such that the first horse rider and the first horse are scheduled to arrive at the first venue location of the particular venue at a same time.

16. The method of claim 14, comprising:
obtaining horse locations for a plurality of horses associated with the horse riders, the horse locations including at least the second location, wherein the second location is associated with a first horse of the first horse rider;
determining, in response to and based on the first start time, a second route for the first horse from the second location to the first venue location, wherein the first route and the second route are determined such that the first horse rider and the first horse are scheduled to arrive at the first venue location of the particular venue at different times.

17. The method of claim 11, wherein the first location represents a current location of the participant, and the second location represents a current location of the thing associated with the participant.

18. The method of claim 11, wherein the instructions cause the system to perform: linking any of the participant and the thing associated with the participant to at least one judge responsible for scoring either or both the participant, and the thing associated with the participant.

19. The system of claim 18, further comprising:
receiving a physical score card to be completed;
generating and uploading an electronic score card based on the physical score card to be completed;
receiving, via a graphical user interface, one or more user inputs drawn on the electronic score card;
converting the one or more user inputs into usable data for scoring either or both the participant and the thing associated with the participant;
determining, based on the converted inputs, a participant score, thereby providing near-real time participant scoring.

20. The method of claim 19, further comprising:
providing the participant score to at least the participant via the interface.

21. The method of claim 11, comprising:
providing an add toggle that, when activated, indicates the participant is to be registered for a second event that is or will be scheduled to occur at a second venue location of the plurality of venue locations associated with the venue;
obtaining a third location associated with the participant;
determining, in response to and based on a second start time associated with the second event, a second route for the participant from the third location to the second venue location;
providing an interface through which the add toggle and the second route are accessible.

22. The system of claim 1, wherein the instructions cause the system to perform:
providing an add toggle that, when activated, indicates the participant is to be registered for a second event that is or will be scheduled to occur at a second venue location of the plurality of venue locations associated with the venue;
obtaining a third location associated with the participant;
determining, in response to and based on a second start time associated with the second event, a second route for the participant from the third location to the second venue location;
providing an interface through which the add toggle and the second route are accessible.
